(19) United States
(12) Patent Application Publication
(10) Pub. No.: US 2008/0251074 A1
(43) Pub. Date: Oct. 16, 2008

(54) System and method for remote oxygen supply monitoring and calculation of replacement requirements

(76) Inventor: Robert H. Sand, Grass Valley, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/904,714

(22) Filed: Sep. 27, 2007

Related U.S. Application Data
(60) Provisional application No. 60/923,272, filed on Apr. 12, 2007.

(51) Int. Cl. A62B 7/00

(52) U.S. Cl. 128/204.18

(57) ABSTRACT

A device and method for remote monitoring of remaining gas supplies in compressed gas cylinders conventionally employed to supply patient oxygen. The device employs a pressure sampling component to communicate sequential electronic signals to a remote receiver of remaining pressure in the tank. Software and a microprocessor in the receiver continually calculate a future replacement time for the tank based on tank pressure depletion identified in the most recent pressure reading of the tank over the time duration from the next most recent pressure reading.

This application claims the benefit of U.S. Provisional Application No. 60/923,272 filed Apr. 12, 2007 and incorporated herein in its entirety by reference. The disclosed system and method relate generally to supplemental oxygen supplies. More particularly, it relates to a system for remote monitoring of the remaining compressed oxygen supply reservoir for a patient in real time and calculation of replacement requirements using calculations based on historical use. The system and apparatus thereby provides an alarm signal to a user such as a caretaker or other third party when remaining high pressure gas inside the oxygen cylinder drops below a predetermined level or approaches a critical level based on historical use by the patient.

### FIELD OF THE INVENTION

### Background of the Invention

Elderly individuals and patients are frequently in need of supplemental oxygen supplies while recuperating or to supplement their breathing due to a lung or circulatory problems. Such supplies are conventional provided in cylinders and tanks containing pressurized oxygen which is supplied over time to the user using a regulator to provide a lower pressure breathing supply metered by an adjustable flow control. Such pressurized tanks conventionally are made from high tensile strength material such as steel, aluminum, or resin-impregnated fiberglass fibers as they must contain gases inside under extremely high pressures. The gas contained in such cylinders can range from 20 cubic feet to 300 cubic feet or more at pressures as high as 2500 pounds per square inch.

Because recuperating patients and breathing impaired individuals can suffer serious injury or even death if their supplemental oxygen supply ceases or is interrupted, it is vital to monitor internal tank pressure of the supply cylinder to continually ascertain the remaining usable gas supply in the canister. This is especially true in the case of portable oxygen supply tanks used in medical, aviation, emergency, and other situations as the life of the user may depend upon a constant supply of oxygen for breathing.

Conventionally employed tank pressure gauge devices are monitored by visual inspection of a mechanical analog style gauge or a digital gauge. This gauge may be attached to a conventional pressure regulator used to reduce incoming high pressure from the tank, to useable pressure and volume via flow control for the patient to breathe. Visual reading of the analog or digital gauge is the normal mode of checking upon the patient's remaining supply. When a caretaker or other third party such as a nurse has multiple patients in multiple rooms on multiple floors, the continual inspection of gauges to ascertain a proper supply for each patient can be daunting and extremely time consuming.

It is an object of this invention to provide a method of remote monitoring of one or a plurality of oxygen tank supplies by a caretaker or third party in a location proximate to the patient or at a location remote to the patient.

It is a further object of this invention to provide such a method and device to initiate visual or audible alarms on the person of a user such as a patient's caretaker if tank supplies of oxygen drop below a preset minimum supply.

It is a further object of this invention to provide such a method and apparatus which will allow one caretaker or third party to monitor oxygen supplies of multiple patients.

It is an additional object of this invention to provide such an oxygen supply monitoring system which will also continuously calculate usage by patients and calculate replacement times and/or a leak condition based on prior usage of respectively monitored tanks.

With respect to the above description and background, before explaining at least one preferred embodiment of the invention in detail, it is to be understood that the invention is not limited in its application to the details of construction and to the arrangement of the components and/or steps set forth in the following description or illustrated in the drawings. The various apparatus and methods of the invention herein described and disclosed are capable of other embodiments and of being practiced and carried out in various ways which will be obvious to those skilled in the art once they review this disclosure. Also, it is to be understood that the phraseology and jargonistic terminology employed herein are for the purpose of description and should not be regarded as limiting.

As such, those skilled in the art will appreciate that the conception upon which this disclosure is based may readily be utilized as a basis for designing of other devices, methods and systems for carrying out the several purposes of the present disclosed device. It is important, therefore, that the objects and claims be regarded as including such equivalent construction and methodology, insofar as they do not depart from the spirit and scope of the present invention.

### SUMMARY OF THE INVENTION

The embodiments of the device disclosed herein are directed at an improved supply tank gas pressure monitoring system which employs transmitters in communication with the gauge of each supply tank and which constantly update one or a plurality of remote receivers adapted to receive and process the transmitted information. Should any single tank reach a pressure which calls for action by the caretaker or other third party monitoring the situation, one or a combination of audible alarms, visual alarms, or electronically transmitted, warnings about low pressure, incorrect flow LPM, and diminishing reserves in any supply tank are broadcast from a user-worn receiver having software and data processing adapted to the task of tracking one or a plurality of tank transmitters.

The receiver worn by a caretaker or other third party receives constant updates from the tank transmitters with regard to remaining pressure in the tank and therefor the remaining supply to the patient. Onboard software in the portable receiver thereby can constantly track each tank. Using historical use data stored in memory on the receiver, and/or calculations as to pressure drop over time in each tank, the software can also calculate a time for the caretaker to change tanks on any individual supply for any individual patient based on current use and historical use. Or the software may be employed to notify the caretaker or another third party who thereafter will cause the tank to be changed by personnel handling such matters.

In one mode of the device which tracks only one tank pressure supply, a plurality of lights or LED's and a buzzer or another audible alarm, combine to inform the caretaker or third party regarding low tank pressure, tank leakage, low battery on the tank gauge transmitter, or that the caretaker has exceeded the range of the transmitter on the tank and is out of contact.

Each user-worn receiver would have a means to engage it to the user such as a belt clip, and may have an earphone plug to allow for private monitoring of audible alarms. In addition to the onboard data processor and software and LED's for visual alarms, the receiver optionally may have an LCD or other display screen to provide more detailed information, or if the receiver is tracking multiple patient to display information concerning each. An optional table or counter receiving cradle can also be provided to recharge the user-worn receiver much like portable radios and telephone are stored temporarily in a cradle to recharge their batteries.

Communication between the receiver and the tank-mounted transmitter in the preferred mode would be by low strength radio employing the ZigBee specification allowing for high-level communication protocols using small, low-power digital radios based on the IEEE 802.15.4 standard for wireless personal area networks (WPANs). Or other standards may be employed if sufficiently powerful and able to carry the digital data required for communication between the receiver and tank transmitter such as Wi-Fi under the IEEE 802.11 standard. For especially large venues with multiple patients a repeater may be employed to relay signals from the tank transmitter to the receivers.

The tank-mounted transmitter employs a pressure transducer to generate an electronic signal relative to the remaining tank pressure which can then be transmitted at a chosen time interval by an onboard transmitter operatively engaged to the transducer. The transmitter would also transmit an identifier which would identify the specific tank being reported upon which is matched up to a location and/or patient by the onboard software of the caretaker or other third party's receiver. In this fashion the receiver will be transmitted timely communications by the tank transmitter as to remaining pressure for the software to calculate an action or alarm for the caretaker or a third party user to take action.

The foregoing summary and following detailed description are considered as illustrative only of the principles of the invention. Further, since numerous modifications and changes will readily occur to those skilled in the art, it is not desired to limit the invention to the exact construction and operation shown and described, and accordingly, all suitable modifications and equivalents which may be resorted to are considered to be within the scope of the invention herein.

### BRIEF DESCRIPTION OF DRAWINGS

FIG. 1 is a graphic depiction of the tank mounted transmitter communicating with a remote receiver and data processor.

FIG. 2 depicts a typical front view of an analog style Oxygen pressure gauge.

FIG. 3 depicts a slice through FIG. 2 showing the transducer and transmitter inside a housing to communicate tank pressure to the remote receiver.

FIG. 4 depicts a typical patient on Oxygen and the remote caretaker or third party user with the receiver clipped to a belt.

FIG. 5 depicts the remote receiver.

### DETAILED DESCRIPTION OF PREFERRED EMBODIMENTS

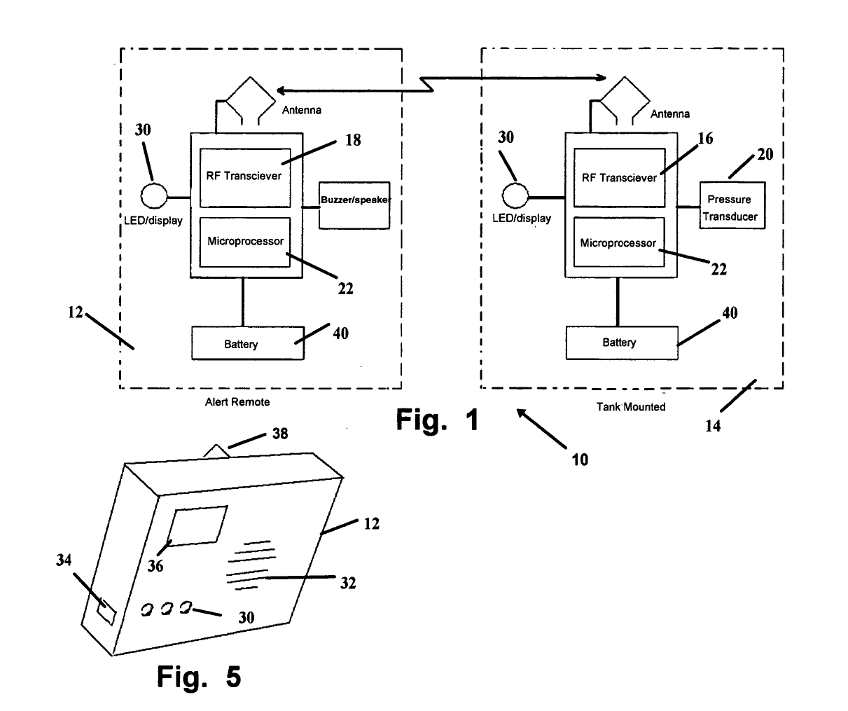

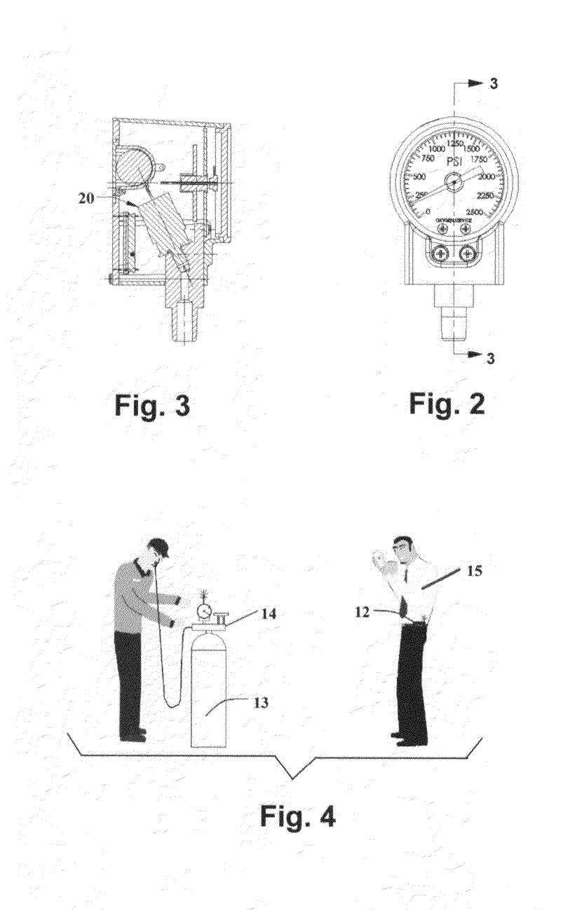

Referring now to the drawings in FIGS. 1-5, some preferred embodiments of the present invention in current preferred modes are shown and described. The device 10 during operation of the system herein provides for a communication between a means for receiving a transmission shown as a receiver 12 and a tank mounted means for transmitting shown as the transmission component 14 which in the preferred mode would employ a low strength wireless transmitter 16 or transceiver on a frequency, and at a signal strength, to communicate with the receiving component 18 in the user-worn receiver 12. The transmission from the transmitter 16 in the transmission component 14 is of sufficient power to communicate the digital data concerning information about remaining tank pressure, which is provided from the pressure transducer 20, the distance between the receiver 12 and tank transmission component 14. Such transmissions would occur for instance with a transceiver employing the Zigbee or Wi-Fi standard. In the event the device is located at a large venue with multiple patients such as a hospital or convalescent home, a repeater (not shown) may be employed to relay signals from the tank transmitter 16 of the transmission component 14 to the user-worn receivers 12.

Means to sample pressure levels in the tank 13 is provided currently by a pressure transducer 20 operatively positioned within the transmission component 14 is adapted to provide a means to generate an electronic digital or analog signal relative to the remaining tank pressure inside the tank 13. This electronic signal containing the sampling of tank pressure information is therein transmitted at chosen time intervals by means for wireless transmission such as the transmitter 16 operatively communicating with the transducer 20 and a microprocessor 22 which is controlled by the software adapted to the task of monitoring the tank pressure and communicating that information at intervals. In cases where multiple tanks 13 are being monitored by one receiver 12 worn by the caretaker 15 or third party with the responsibility, the transmitter 16 in each respective transmission component also transmits an identifier which provides a means to identify the specific transmission component which is matched to a specific tank 13 being reported upon. In the mode of the device 10 where a single tank 13 is monitored by one receiver 12 this would of course not be necessary.

The identifier is employed by the onboard microprocessor 22 in the receiver 12 running software adapted to the task, to match up the identifier received in the electronic transmission, to a tank 13 at a specific location and/or a specific patient in the caretaker's 15 or third party's care using a lookup table or other matching reference data stored or available to the receiver 12 and its software. The caretaker 15 or third party with monitoring responsibility thus has continual real time information about diminishing level of the Oxygen supply in each identified individual tank 13 as they relate to individual patients from the tanks 13 they are associated with by the software.

In operation while monitoring on or a plurality of tanks 13 with identifying transmission components 14 engaged and transmitting, the microprocessor 22 of the receiver 12 and software running thereon, will initiate one or a combination of means for audible or visual alarms or notifications, to alert the caretaker 15 or third party in charge. The specific alarm or notification activated is based on the information received in the electronic signal transmitted about a specific tank 13. This allows the caretaker 15 or other user monitoring the situation, in any remote location sufficiently proximate, to receive the transmitted signal from one or a plurality of tank-engaged transmission components 14, to monitor one or a plurality of respective tanks 13 and thus patients.

In the method of operation, the software running on the receiver 12, in the particularly preferred mode of the device and method, is enabled with a software routine or algorithm which calculates and predicts tank change intervals or times to a caretaker 15 or third party responsible for the patient, for each respective tank, based on diminishing supply. This replacement calculation estimates a depletion level at a future time where replacement is necessary, by employing memorized historical gas-use data from an identified tank 13 associated with a specific patient, and extrapolating a future time of exhaustion of the gas supply in that tank 13. The caretaker 15 or other user monitoring the patient is then given information to plan and schedule timely tank replacements.

The visual alarms on the device would include illumination means such as LED's 30, audible means of alert such as speaker 32, a vibrating means of alert such as vibrator 34 and optionally a display 36 which can be employed to allow the microprocessor 22 to inform the caretaker 15 or user wearing the device, about calculated replacement times of any single tank 13 or regarding the information about a plurality of tanks 13 in a plurality of locations.

In the preferred mode of the device and method, because of the wide variance in tank volume and thus Oxygen capacities employed in the industry, the estimated replacement time for any tank 13 will employ the transmission component 14 engaged to that tank 13 to periodically measure and make individual samplings of the gas pressure remaining in the respective tank 13 at consecutive time intervals using for example the formula P/(D/T) where the remaining pressure in the tank 13 at the end of the most recent time interval is “P” and the drop in pressure over the most recent time period is “D” and the duration of the most recent time interval between measurements is “T”. Using this calculation of depletion over the most recent time period is the preferred predictor due to the noted wide variance in the industry for tank volume. This periodic measurement can be initiated by onboard software in the transmission component 14 to sample, and then broadcast the measured remaining tank pressure at the times appropriate to the consecutive intervals chosen.

The software on the receiver 12 operating on the microprocessor 22 calculates the difference between each consecutive pressure measurement transmitted about each respective tank 13 to which the respective transmission component is engaged. Of course those skilled in the art will realize the software might also be resident in the transmission component 14, and thereby make calculations which could be transmitted to the receiver and such is anticipated. In a further calculation, the software divides the most recent communicated remaining pressure reading by the intervening time since the last such reading. This calculation provides a rate of a pressure drop in each respective monitored tank 13. The pressure drop rate from the most recent pressure reading over time is a straight line when graphed, and using an algorithm or software employing this data, a substantially exact time of total depletion of tank pressure is calculated for the estimated future time when the pressure in a monitored tank 13 will be zero. Using the most recent time interval as the divider is also preferred in case the patient has begun to breathe rapidly and hence use the remaining supply faster than the previous measured time periods.

Employing this method of pressure depletion and replacement calculation over consecutive time periods of the individual pressure measurements, the replacement time of any capacity Oxygen tank can be calculated independent of its size since the method employed ignores the tank dimensions and calculates a pressure drop against time rather than a known tank volume. Consequently, using the software adapted to this task, any transmission component 14 may be engaged to any sized tank 13 and a variance in that tank size or capacity need not be input into the software of the transmission component 14 or receiver where the calculations on depletion are made. This is most important in a hospital type setting where mistakes are easily made by employees for such things as compressed gas tank volume, and where many different vendors might supply such tanks in differing capacities.

In operation, a predetermined time point before the calculated time of zero pressure in a tank 13 will be ascertained to give the caretaker 15 or other third party user a safe window to change to a new tank 13 without allowing the previous tank 13 to run out. This would be input as a default time of replacement in the software running on the device. Thereafter, at a predetermined time before the calculated zero pressure in a monitored tank 13, the device initiates an alarm to the caretaker or other user to take the appropriate action of changing the tank. This is based on the continuous monitoring and calculation of tank pressure over time at each successive measurement of tank pressure. Should the predetermined replacement time of any tank 13, before the calculated zero pressure of that tank 13 be passed, one or a plurality of audible and visible alarms will be given to the caretaker identifying the sampled low pressure and diminishing reserves in any supply tank 13 and thus the need to change it. The caretaker 15 or other third party user will be continually informed of the need to change a tank 13 that has reach the change point in time, until it is changed. Changing the tank 13 provides a means to reset the software to start over and record a tank change and such a reset is initiated when the pressure reported on a sampling by the device is above the prior reading for the transmitter identified as engaged to that tank 13, wherein the system will reset the monitoring of the changed tank 13 and stop any alarms.

Each user-worn receiver 12 would have a means to engage it to the caretaker 15 or other user such as a belt clip 38, and may have an earphone plug to allow for private monitoring of audible alarms. Onboard batteries 40 would power both the transmission component 14 and the receivers 12 and can be rechargeable by placement in a conventional recharging cradle such as those used for radios and telephones.

The device and method for providing remote real time monitoring of patient oxygen supplies by a remote caretaker or user, shown in the drawings and described in detail herein, disclose steps in a process, arrangements of elements of particular construction, and configuration for illustrating preferred embodiments of structure and method of operation of the present invention. It is to be understood, however, that elements of different construction and configuration and different steps and process procedures and other arrangements thereof, other than those illustrated and described, may be employed for providing the apparatus and any method herein within the spirit of this invention.

As such, while the present invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. An apparatus for monitoring of remaining gas supplies in compressed gas cylinders comprising:
means to sample gas pressure in said gas cylinder and produce an electronic signal representative of individual pressure readings of remaining gas pressure in said cylinder;
said individual pressure readings being taken at a plurality of consecutive sampling times, each said consecutive sampling time being a time duration subsequent from a prior said sampling time;
means to electronically identify said gas cylinder with an electronic identifier;
means to receive said electronic signal and said electronic identifier and transmit them to a remote receiver in a transmission;
said remote receiver having a microprocessor and software; and
said software calculating a depletion time for said gas cylinder upon receipt of said transmission, said depletion time being a future time when said gas cylinder is substantially zero;
said software calculating a replacement time, earlier than said depletion time, said replacement time defining a time to change said gas cylinder; and
said remote receiver having means to communicate said replacement time to a monitoring user, whereby said monitoring user is informed to replace said gas cylinder prior to said depletion time.

2. The apparatus for monitoring of remaining gas supplies of claim 1 additionally comprising:
means to issue an audible or visual alarm of an impending said replacement time until said pressure reading of said tank communicated in a said transmission, is higher than a prior said pressure reading communicated in a prior said transmission, whereby said alarm is continually given said alarm until said tank is replaced.

3. The apparatus for monitoring of remaining gas supplies of claim 1 additionally comprising:
said electronic identifier identifying said gas cylinder being related with an individual user for said gas cylinder;
said software having a database of historical use by said individual user of similar said gas cylinders, said historical use defining a depletion rate; and
said software calculating said depletion time based on said most current said pressure reading and said depletion rate, wherein said replacement time can be calculated based on said depletion rate of each individual said user.

4. The apparatus for monitoring of remaining gas supplies of claim 2 additionally comprising:
said electronic identifier identifying said gas cylinder being related with an individual user for said gas cylinder;
said software having a database of historical use by said individual user of similar said gas cylinders, said historical use defining a depletion rate; and
said software calculating said depletion time based on said most current said pressure reading and said depletion rate, wherein said replacement time can be calculated based on said depletion rate of each individual said user.

5. The apparatus for monitoring of remaining gas supplies of claim 1 wherein said software calculates said depletion time of said remaining gas pressure in said gas cylinder based on the formula P/(D/T) where the remaining pressure of said tank at the sampling time most recent is “P” and the drop in said gas pressure over the most recent time period is “D” and the duration said time duration is “T”, whereby a new said depletion time is calculable with each subsequent said pressure reading based on a rate of use over the duration of time since the preceding said pressure reading.

6. The apparatus for monitoring of remaining gas supplies of claim 2 wherein said software calculates said depletion time of said remaining gas pressure in said gas cylinder based on the formula P/(D/T) where the remaining pressure of said tank at the sampling time most recent is “P” and the drop in said gas pressure over the most recent time period is “D” and the duration said time duration is “T”, whereby a new said depletion time is calculable with each subsequent said pressure reading based on a rate of use over the duration of time since the preceding said pressure reading.

7. A method for monitoring remaining gas supplies remaining gas in compressed gas cylinders and calculating a future time to replace said cylinder comprising the steps of:
employing a means to sample gas pressure in said gas cylinder and produce an electronic signal representative of individual pressure readings of remaining gas pressure in said cylinder;
taking said individual pressure readings at a plurality of consecutive sampling times with each said consecutive sampling time being a time duration subsequent from a prior said sampling time;
employing a means to electronically identify said gas cylinder with an electronic identifier;
employing a means to receive said electronic signal and said electronic identifier and transmit them to a remote receiver in a transmission;
employing software and a microprocessor said remote receiver to calculating a depletion time when pressure in said gas cylinder is substantially zero to then calculate a replacement time, earlier than said depletion time to change said gas cylinder; and
and employing means to communicate said replacement time to a monitoring user, whereby said monitoring user is informed to replace said gas cylinder prior to said depletion time.

8. The method of claim 7 additionally comprising the steps of:
employing means to issue an audible or visual alarm of an impending said replacement time until said pressure reading of said tank communicated in a said transmission, is higher than a prior said pressure reading communicated in a prior said transmission, whereby said alarm is continually given said alarm until said tank is replaced.

9. The method of claim 7 additionally comprising the steps of:
relating said electronic identifier identifying said gas cylinder with an individual user for said gas cylinder;
providing a database of historical use by said individual user of similar said gas cylinders, for lookup by said software to calculate a depletion rate; and
calculating said depletion time based on said most current said pressure reading and said depletion rate of each individual said user.

10. The method of claim 7 additionally comprising the steps of
employing the formula P/(D/T) in said software, where the remaining pressure of said tank at the sampling time most recent is “P” and the drop in said gas pressure over the most recent time period is “D” and the duration said time duration is “T”, to calculate a new said depletion time with each subsequent said pressure reading based on a rate of use over the duration of time since the preceding said pressure reading.

11. The method of claim 8 additionally comprising the steps of
employing the formula P/(D/T) in said software, where the remaining pressure of said tank at the sampling time most recent is “P” and the drop in said gas pressure over the most recent time period is “D” and the duration said time duration is “T”, to calculate a new said depletion time with each subsequent said pressure reading based on a rate of use over the duration of time since the preceding said pressure reading.
